(19) United States
(12) Patent Application Publication
(10) Pub. No.: US 2005/0196513 A1
(43) Pub. Date: Sep. 8, 2005

(54) Egg-like food product

(76) Inventors: David Adrian Lewis, Bellevue Hills (AU); Deborah Ann Lewis, Balmain (AU)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/065,846

(22) Filed: Feb. 25, 2005

(30) Foreign Application Priority Data
Feb. 27, 2004 (AU) 2004901000

(51) Int. Cl. A23L 1/32

(52) U.S. Cl. 426/614

(57) ABSTRACT

The present process is directed to an egg-like food product which comprises a soy protein containing component and egg white, the average particle size being less than about 100 microns, the soy protein containing component being present in at least 10% by weight of the composition and to the process of preparing same.

### BACKGROUND OF THE INVENTION

This invention relates to egg-like food products, and processes for making such products.

Use of eggs in the diet is widespread. Their versatility is evidenced in the vast range of recipes which call for eggs as a major or a minor component. Eggs provide an excellent source of protein, as well as vitamins, minerals and fat.

Eggs have many functional properties including emulsifying, aerating and thermal setting characteristics, which account for the wide use of eggs in foods. The characteristic of thermal setting is especially important. The functions of emulsification and aeration are not unique to eggs but the combination of all three functions in a single natural food is unique.

However, eggs also are a major dietary source of cholesterol, a characteristic which has resulted in disfavour of eggs for persons suffering from hypercholesterolemia and coronary heart disease or seeking to reduce the risk of heart disease. The source of cholesterol is found in the egg yolks. Whole egg contains 375 mg cholesterol per 100 g and egg yolk contains 1050 mg per 100 g.

Eggs are widely used as an industrial ingredient in such food categories as bakery products, mayonnaise, and salad dressings and in desserts. Eggs represent an expensive ingredient for such industries and thus tend to be used as sparingly as possible. Liquid egg products, as used by industry, require pasteurizations to reduce the hazards from microbial spoilage and even so have a limited safe storage life under refrigeration. Frozen egg products, either sugared or salted, pose problems in storage, thawing and reduced functionability and versatility.

Eggs in the shell are convenient to household uses but not for industrial uses. Shell eggs lose their freshness quickly, even when refrigerated, and eventually spoil.

Dried egg products are commercially available. Whole egg and yolk in dried form are subject to flavour deterioration due to oxidative and other changes. They do not always deliver the flavour or functional quality typical of fresh eggs. They do find application for use in ration packs for armed forces and also as a portable, non-perishable food for hikers and outdoor activities, but there is considerable sacrifice in quality delivery and versatility.

Dried egg white lacks the unique emulsifying and nutritional qualities of the yolk component, is slow and difficult to rehydrate, and may fail to achieve the functionality of fresh egg white.

Eggs naturally come in a very neat package; but this package is a fragile so that considerable cost is incurred in delivery of whole shell eggs to the various markets.

Eggs are a rich and sustaining food. This is partly because of the high protein and fat content of eggs. Thus, on a moisture free basis, whole egg comprises and then cooked to produce scrambled eggs or whatever. The product thereof is thus a high moisture product.

In U.S. Pat. No. 4,296,134, Boldt describes a liquid egg blend containing less than 1.25% by weight of fat. It comprises liquid natural egg whites, water and a protein replacement, such as non-fat dried milk solids, powered egg albumen and soy protein, and vegetable gum. Boldt envisages soy protein (88-90% protein) addition, but states that its flavor is detectable above 0.9%, and that it also imparts a reddish colour. Moreover, Soy protein addition was limited to about 1.5%. He further states the product described therein may be marketed as a chilled liquid product or it may be frozen for future use. He also found that there was a limit to the amount of egg albumen in dry form since it imparted a distinct flavor which was detectable at about 1.5% unless masked by a flavorant.

There remains an un-met need for an egg-like or egg-analogue food product which would deliver to consumers the various desirable characteristics of eggs without the negative aspects referred to above. There are, of course, other foods which are high in protein and are cholesterol-free. Notable amongst these are various fractions derived from soybeans. For example a simple full-fat flour prepared from dry dehulled soybeans has protein and fat contents of about 43% and 20% respectively but the flavour is very strong and unattractive for use as a major food component. Such a flour has useful emulsifying characteristics but little or no heat-setting properties. Other dry soy preparations include soy concentrate at about 70% protein and soy isolate at 90% protein. These products are useful food ingredients but do have some residual beany soy flavour which reduces their acceptability. They contain no fat and require high shear mixing to achieve solubilisation or dispersion. Full fat soy flours which have been processed in a controlled way, as exemplified by the products of Australian Patent No. 559,031 (incorporated herein by reference) have the required bland flavour, high stability, easy wetting, dispersion and outstanding emulsifying properties but is lacking in any significant heat-setting properties.

It is surprising that a combination of a high protein full-fat soy product and a heat-settable egg white product is found to be useful as a means of producing a dry cholesterol-free, instantly dispersible, bland tasting, fully functional, high protein egg-like food product. However, heretofore, simple combinations of available egg white and available soy preparations have not been found to be successful in delivering the functionalities and eating qualities required for an instant dry food preparation that simulates whole fresh egg.

This may be because while available soy flours are seemingly of fine texture they are not smooth on the palate when consumed in a moist or wet food preparation. Such smooth texture on the palate is a characteristic of egg-based foods such as omelettes, scrambled eggs, egg custards and the like.

Likewise, available spray-dried egg-white preparations do not rehydrate with the speed required for an instant dry preparation as required for such egg-like food products in dry formats. Other egg replacement/analogue systems have been marketed. One of these comprises a mix of flour, starch and gums but it lacks significant protein component and emulsifying functions (Orgran Natural Foods, Australia and United Kingdom).

However, the present invention overcomes the problems described hereinabove. More specifically, the present invention is directed to an egg-like product, which overcomes the problems associated heretofore with a high protein soy product and an egg white product.

### SUMMARY OF THE INVENTION

In accordance with a first aspect of this invention there is provided an egg-like food product, which comprises a soy protein and egg white. Preferably, the product has a smooth mouth feel for example, either as a dry preparation or when in a hydrated or liquid state. Smooth mouth feet is associated with an average particle size of less than about 100 microns (μm). Thus, the particles in the egg-like food product of the present invention have average particle sizes of less than about 100 microns, more preferably less than about 50 microns, and still more preferably less than about 30 microns, and most preferably between about 20 microns and about 30 microns. The average particle size of the components of the present invention while preferably being less than about 100 microns is preferably greater than about 0.1 microns and more preferably greater than 1 micron and even more preferably greater than about 10 microns and most preferably greater than about 20 microns. In a more preferred embodiment, the average size of the soy protein and egg whites present in the egg-like food product of the present invention is between about 1 micron and about 70 microns and more preferably greater than about 20 microns and less than about 60 microns. In an even more preferred embodiment, the average particle size is between about 10 microns and about 50 microns and more preferably between 20 microns and about 30 microns. A smooth mouth feel is generally provided by homogenizing or refining in a manner such that the functionality and the normal heat setting character of the egg white component and the soy component are not impaired to any substantial degree. The homogenised liquid product, prepared as described, may be pasteurised and spray dried, or may be pasteurised and chilled or frozen.

In another aspect, the invention comprises a blend of a soy protein-containing component and egg white in a proportion selected to give a desired compositional balance of soy protein and egg white protein. Optionally, the mixture so formed includes a fat, such as an oil, for example, vegetable oil, soy oil, or vegetable fat, or other fats.

In a further aspect, the invention comprises a blend of homogenised or refined dry soy protein-containing component and liquid egg white in a proportion selected to give a desired compositional balance of soy protein and egg white protein. Optionally, the mixture so formed includes an oil or fat such as a vegetable fat. Water may be added.

In another aspect of this invention, there is provided a process for production of an egg-like food product, which comprises blending a soy product, preferably full fat soy flour, with egg white, and optionally, subjecting the blend to a mechanical treatment to produce a product having a smooth mouth feel.

In an embodiment of the present invention, there is provided an egg-like food product containing a lower fat content than natural egg. Another embodiment of the present invention is directed to an egg-like food product, which duplicates the compositional characteristics of a real hen egg, except that the product contains no or substantially no cholesterol. The product can contain as little as 2% fat, such as in the wet product, and may contain as much as 35% fat.

In another aspect of this invention, there is provided a process for the production of a fluid egg-like food product which comprises blending a soy protein-containing product, for example, full fat soy flour, with dried egg white in the presence of one or more fats, for example vegetable oil, to provide a free flowing crumb-like admixture, and thereafter subjecting the dry blend to a mechanical treatment to produce a fine particle size such that the blend may be readily hydrated. The product has a smooth mouth feel. The expression “readily hydrated” is meant to indicate that on addition of a specified amount of water at room temperature or 24° C. (75° F.) the blended dry product becomes fully dispersed/dissolved by mixing for about 30-60 seconds. The blending step described hereinabove is effected at effective temperatures, most preferably the temperature is at about room temperature, although it can be preferably performed at or about 10° C. above or below room temperature.

In another aspect of this invention, there is provided a process for the production of an egg-like food product which comprises blending an homogenised or refined soy protein-containing product, for example full fat soy flour, with liquid egg white in the presence of one or more fats, for example vegetable oil. Optionally, the blend is homogenised to provide a product having a smooth mouth feel. The homogenised liquid product of this aspect may be pasteurised and dried by means known in the art, e.g., by spray drying or vacuum drying or other means. Alternatively, they may be pasteurised and/or chilled or frozen. Again, the blending step is effective at effective temperatures, most preferably at about room temperature, although it can also be effected at about 10° C. above or below room temperature.

### DETAILED DESCRIPTION

The invention comprises, in an embodiment, a product, which is a blend of a soy protein-containing component and an egg white component. The product may be either a dry preparation or a liquid preparation.

The soy product utilised in the present invention is a soy protein-containing component prepared from soy beans, including soy protein isolate, soy concentrate, defatted or partially defatted soy flour, or full fat soy flour, or even refatted soy flour or concentrate, and the like. As used herein, unless indicated to the contrary, the “soy protein-containing component” is a product containing soy protein(s).

The soy protein is isolated from the soybean by known techniques. For example, a typical commercial process for the production of soy protein concentrates may involve extracting defatted soy flakes with aqueous alcohol so as to recover a soy protein concentrate.

Soy flour can be produced from grinding soy flakes after most of the oil has been removed from the beans, for example by solvent extraction. Such soy flours may contain about 50% protein on a moisture-free basis. Soy protein concentrate is a further refined product prepared from defatted soy flakes by removing most water soluble non-protein components. Soy protein concentrate typically contains not less than 65% protein on a moisture-free basis. The aforementioned soy components are readily available commercially.

Whereas whole dehulled soybeans contain in the order of only 40% protein, defatted soy flour, soy protein concentrate, and isolated soy protein (soy protein isolate), can typically comprise 50%, 65% and 90% protein respectively. The soy product used in this invention may additionally comprise one or more isoflavones, which for example may be added back to the product if removed during processing.

For a dry or liquid preparation, the soy component may be a soy protein isolate, soy concentrate or a defatted soy flour, or more preferably a full fat soy flour of low flavour profile as exemplified, for example, by the product of Australian Patent No. 559,031 referred to as PSM (incorporated herein by reference) or U.S. Pat. No. 4,748,038, which is also incorporated by reference of the component discussed hereinabove.

Of the various available forms of soy, high quality full fat soy flour and especially PSM is preferred because of its low soy flavour profile, its natural buttery, egg-like flavour, its high degree of functionality with respect to protein quality, protein solubility, emulsifying properties and antioxidant properties, its content of all the beneficial natural components of whole soy (cotyledons), its natural soy oil content, its low cost and its egg-like colour. One may also use a blend of soy components including from the range of soy products available including, but not limited to defatted soy flour, soy protein concentrate and soy isolate.

The egg component that is utilized in the present invention is egg white. Egg white may also be referred to as egg alburnen. Egg white accounts for most of an egg's liquid weight, on the order of about 67%. Egg white includes a number of protein/glycoproteins such as ovomucoid, ovalbumen, ovotransferren, lysozyme, ovomucin, G2 ovoglobulin, G3 ovoglobulin, ovoflavoprotein, ovostatin, cystatin, and avidin, as described for example by Awade et al 1994, J. Chromatogr. A 677: 2798-288, and the like. Egg white additionally includes various vitamins, lipids (minimally), carbohydrates and minerals, as described, for example in Deutsche Forschungsanstalt für Lebensmittelchemie, Garching bei München (ed), Der kleine “Souci-Fachmann-Kraut” Lebensmitteltabelle für die Prazis, WVG, Stuttgart 1991.

For a product marketed as a dry product the egg white component is generally spray-dried or otherwise dried egg white. Alternatively, it may be egg white solids.

The egg source of the present invention is preferably egg white separated from whole egg. “Egg”, as used herein, refers to all edible poultry eggs, including chicken eggs, goose eggs, and quail eggs, and preferably chicken eggs. “Egg white”, as used herein, refers to the above-mentioned type of egg from which the yolk has been removed. It is preferred that the egg white is obtained from chicken eggs. The egg white utilized in the present invention can be in liquid, frozen or dry powder form, or combination thereof. For a product marketed as a liquid product, the egg white component is liquid egg white, separated from the yolk as is readily available from industry in a chilled or frozen form and preferably pasteurised. By readily hydratable, it is meant that the dry preparation, when added to a specified amount of water at about room temperature or 24° C. (75° F.) and mixed, will be fully wetted and hydrated within about 30-60 seconds. The egg white may optionally contain minor amounts of additives, including sodium lauryl sulfate, (SLS or SDS) or triethyl citrate (TEC) as whipping aids for dried and frozen egg whites. The preferred egg source is an egg white product produced from the breaking and separation of whole shell eggs. This egg source may be raw and more preferably pasteurised prior to separation of the egg white from the egg.

As used herein, the “egg white component” is “egg white”, as defined hereinabove, which optionally may contain additives as, described hereinabove.

The egg white and the soy component are present in the egg like product of the present invention in the amounts effective to obtain a product which has a smooth mouth feel and which provides an egg like texture and taste, while containing at most trace amounts, such as less than about 1% by weight of cholesterol.

In a preferred embodiment, the soy protein containing component is present in at least about 10% by weight of the egg-like product of the present invention and at most about 50% by weight and more preferably at least about 12% by weight and at most preferably about 40% by weight.

In a dry mix preparation PSM (or similar full fat soy-flour) may be used at a rate of from about 15% to about 50% by weight of the finished dry mix, more particularly about 25% to about 45% and preferably about 30% to about 40%. If soy isolate or soy concentrate is used in place of PSM or other full fat soy flours, it will be present in sufficient amounts as to impart the required quantities of soy protein into the final food as would PSM at the above mentioned rates.

The egg white component is preferably present in less than about 75% of the egg like product of the present invention and more preferably less than about 70% of the product and more preferably less than about 65% by weight of the product. It is preferred that it is present in at least about 25% by weight and more preferably at least about 35% by weight of the egg like product. In a preferred embodiment, the egg white component is present in an amount ranging from about 25% by weight to about 75% by weight and more preferably from about 30% by weight to about 70% by weight and most preferably from about 35% by weight to about 65% by weight.

It is preferred that the weight ratio of egg white to soy protein, including PSM, in the present invention ranges from about 1:2 to about 10:1 and more preferably from about 1:1 to about 8:1 and most preferably from about 1:1 to about 6:1, respectively.

In a dry mix preparation, dry egg white is a complimentary source of heat setting protein when hydrated. It is preferably present in amounts in dry form ranging from about 25% to about 50% by weight of the finished dry mix, more preferably from about 30% to about 42% by weight and most preferably from about 35% to about 40% by weight of the dry egg-like product. The soy protein is preferably present in amounts ranging from about 10% to about 50% and more preferably from about 20% to about 40% by weight of the product. It is to be noted that the amount of soy protein in the product of the present invention is present in amounts less than or equal to the egg-white component. In the dry mix preparation, the ratio of egg white to soy protein preferably ranges from about 1:2 to about 5:1 and more preferably from about 1:1 to about 3:1 and most preferably at about 1:1, respectively.

It is within the scope of the present invention to vary the proportional relationship between the soy component and the egg white component without departing from the spirit of the present invention. Likewise, the proportional relationship between the liquid egg white component and the soy component may be varied without departing from the spirit of the present invention.

The resultant refined dry product, when mixed with water preferably at about room temperature or 24° C. (75° F.), reconstitutes rapidly to a whole-egg-like product when so rehydrated.

Where liquid egg white is used in combination with a source of soy protein the respective rates of usage may be similar to the rates of usage in the dry mix. Due allowance is made for the natural moisture content of liquid egg white, which has a water content of about 87-88% w/w, and for the observation that the heat setting strength of liquid egg white (on an equivalent protein basis) is greater than that of rehydrated sprayed dried egg white. For example, liquid egg white is preferably used in an amount from about 10% to about 90% w/w of the final liquid mix, more particularly 40-80%, and preferably 50-70% of the final liquid mix. Preferably, the weight ratio of egg white to soy protein when liquid egg white is utilized ranges from about 2:1 to about 10:1 and more preferably from about 4:1 to about 8:1, respectively.

Egg white on a moisture free basis comprises about 88% protein. PSM has a protein content of 40-43% and a natural oil content of about 20%. Other soy preparations derived from by-products of the oil extraction process can have protein contents ranging from about 50% to about 90%. Any of these soy preparations may be used in the present invention as set out above. It is clear that a blend of selected soy component and dry or liquid egg white can result in any chosen protein content and can, if required, approximate the protein content of whole egg (about 55%) on a dry weight basis.

The product of the present invention is substantially free of cholesterol. More specifically, the product of the present invention is preferred to have at most 1% cholesterol and more preferably to have at most about 0.1% cholesterol and most preferably at most about 0.05% cholesterol (w/w). The final dry product is readily hydratable and preferably has a smooth mouth feel.

Thus, the product of the present invention is a blend of the two components, soy and egg white, as described herein. Optionally, and more preferably, a proportion of an oil or fat, preferably a vegetable oil, may be added thereto. Vegetable oils include but are not limited to cottonseed oil, canola oil, sunflower oil, rapeseed oil, sesame oil, corn oil, peanut oil, safflower oil, soybean oil and the like. The vegetable oil may be fully hydrogenated or partially hydrogenated. Alternatively, the vegetable oil may be a mixture of one or more vegetable oils or fully hydrogenated or partially hydrogenated vegetable oil. The preferred vegetable oil is soy oil. The vegetable oil is preferably present in the range of about 0.1 to about 30% w/w % and more preferably from about 1 to about 20% w/w of the egg-like product. It has been found that a combination of a soy component plus egg white, dry or liquid, plus vegetable oil can provide the approximate composition of natural hen's eggs in terms of protein and fats as well as providing in large measure equivalent functionality. The addition of a specific quantity of vegetable oil to both the dry egg-like products and the liquid egg-like products respectively results in a final composition, which approaches closely the general composition of natural hen eggs. For example, the vegetable oil may be added in an amount from about 0% to about 30% w/w. However it is within the scope of the invention to vary the level of oil addition without departing from the integrity of the invention.

Where dry egg white is used a certain amount of water is required to reconstitute the product to a final liquid form. Where liquid egg white is used a lesser amount of water is required.

Thus, water is also a component of the product of the present invention. However, the amount varies, depending on whether a dry or wet formulation is used. It is preferred that the moisture content of the dry egg-like product of the present invention ranges from about 2 to about 10 and more preferably from about 3 to about 6 and most preferably from about 4 to about 5% (w/w) of the product. On the other hand, in the liquid egg-like product of the present invention the amount of moisture preferably ranges from about 65 to about 85% and more preferably from about 68 to about 80 and most preferably from about 70 to about 75% (w/w) of the product.

Moreover, it is within the scope of the invention, however, to vary the proportional relationship between the refinate and the water-content used for preparation of the final product without departing the principle of the present invention.

Of course while the dry preparations are typically admixed with water to provide an egg-like food ready for cooking usages, it is within the scope of the invention to use other liquid aqueous food components such as skim milk or other types of milk, various stocks such as vegetable stock, meat stock or chicken stock and the like without departing from the principle of the invention, bearing in mind that such alternative liquids may conceivably contain traces of cholesterol.

The pH of the product of the present invention is the same or about the same as the pH of the egg from which the egg white was obtained.

Other optional ingredients, such as colouring and mineral supplements may be added to the egg-like product of the present invention. Colouring is important from the standpoint of marketability. Examples of colouring agents include FD&C Yellow No. 5, or any similar FDA approved colour, e.g., Durkee's “Egg shade”. If present, it is present in trace amounts, such as from about 0.01% to at most about 20% by weight and more preferably from about 0.1% to about 10% by weight and most preferably from about 0.1% to about 5% by weight.

The vitamin components include Vitamin A, B, E and the like. Minerals include potassium, phosphorous, magnesium, sulfur and sodium and the like. They also may be present in their salt form. Preferably the mineral components are present in an amount from about 0.01% to about 2% by weight of the final product. Additional mineral supplements, such as additional calcium, zinc and other trace elements and additional vitamins may be added to the egg-like food product of the present invention.

Flavouring agent may also be added to the product. These include dextrose, monosodium glutamate, spice extracts, including but not limited to, onion, turmeric, celery and pepper, and the like, and salt and the like. If present, they are present in flavouring effective amounts, such as from about 0.1% to about 10% (w/w) and more preferably from about 0.5% to about 5% (w/w).

Stabilizers, which comprise one or a plurality of constituents, which serve to emulsify as well as to stabilize the product, may be added. Examples include but are not limited to vegetable gums, e.g., locust (carob) bean gum, agar gum, carrageen, guar, gum tracanth, each of which may optionally be mixed with dextrose, certified starch, propylene glycol, alginate, carrageen and mono and diglycerides. If present, the stabilizer is present in stabilizing effective amounts preferably ranging from about 0.1 to about 4% by weight of the product.

Emulsifiers may additionally be present. Preferred are commercially available emulsifiers, such as lecithin, lysolecithin, phosphatidyl-choline rich fractions of lecithin, polysorbates, mono and diglyceride, diacetyl-tartaric acid esters of mono and diglycerides, monosodium phosphate derivative of mono and diglycerides, polyoxyethylene sorbitan fatty acid esters, sucrose fatty acid esters, esters of acids selected from the group consisting of fumaric, lactic, tartaric and citric acids in combination with fatty acids or fatty alcohols, esters of acids selected from the group consisting of fumaric, lactic, tartaric, citric, acetic and succinic acid in combination with mono or diglycerides, or a combination thereof and the like. The emulsifier, if present, is present in emulsifying effective amounts. Preferably it is present in amounts ranging from about 0.05 to about 5% and more preferably from about 0.1 to about 1% by weight.

pH adjusting agents may be added to bring the pH of the egg-like product to that of the natural egg from which the egg white is obtained. These agents are added in amounts effective to achieve this objective. Examples of such agents included acids and bases normally found in food products, such as hydrochloric, sulfuric, phosphoric, acetic, lactic malic, tartaric, and citric acids and the like or sodium or potassium hydroxide, phosphate, carbonate, bicarbonate and the like. It is preferred however that the pH of the egg-like product is adjusted to the pH levels found in hen eggs.

Preservatives known in the art may also be present. Examples include potassium sorbate, sodium benzoate, methyl paraben, propyl paraben or combinations thereof.

If present, they are present effective amounts, preferably less than about 1% (w/w).

Antioxidants known in the art may additionally be present. Examples include tocopherol, ascorbic acid, and the like. If present, they are present in anti-oxidant effective amounts. They are preferably present in amounts of less than about 4% by weight.

Sweeteners may also be present. The sweetener can be a carbohydrate, and preferably a food grade carbohydrate. Examples include corn syrup solids, corn syrup, lactose, dextrins, sucrose, dextrose, fructose, starch, modified starch, fructose, maltodextrine, polydextrose, polyhydric alcohols, combinations thereof and the like. If present, the sweetener is present in sweetening effective amounts. Preferably the sweetener is present in amounts ranging from about 0.5 to about 8% by weight of the product and more preferably from about 1% to about 5% by weight.

In another embodiment, the sweetener may be a non-nutritive sweetener. Examples include sucralose, aspartame, acesulfame (e.g., acesulfame-K), neohesperidin dihydrochalcone, stevia sweeteners, thaumatin, glycyrrhizin, maltitol, lactitol, isomalt, fructooligosaccharide sweetener, and the like. If present the non-nutritive sweetener is present in the egg-like food product of the present invention in amounts as low as 0.005% by weight of the egg-like food product of the present invention. It is preferred, that if present, it is present in amounts of about 0.05% to about 2.5% by weight of the egg-like food product of the present invention.

One of the preferred and most versatile forms of the invention comprises a dry admixture of the preferred full fat soy flour (referred to as PSM) and dried egg white, along with a requisite proportion of vegetable oil with or without the other supplementary ingredients described hereinabove. This results in a free flowing crumb-like admixture which is surprisingly resistant to oxidation and rancidity. Use of a full fat, bland-tasting soy flour also provides the full range of desirable nutritional components of the whole soybean (cotyledons).

As indicated hereinabove, the fat content of the egg-like composition of the present invention may be varied to be less than or equal to that of a natural egg. The preferred fat content of the egg-like product ready for use in accordance with the present invention ranges from 2% to about 35%, by weight of the composition. However, it is preferred that the fat content is less than about 10% (w/w) of the composition, but it not less than 2%. The egg-like food product more preferably contains from about 4% to about 10% and most preferably from about 5% to about 9% by weight of the composition.

A further preferred form of the invention is a product where a mechanical treatment of the dry egg white—PSM—oil mix is carried out to render the particle size as fine as possible, down to a particle size where the egg white particles are both instantly hydratable and also rendered non-reclumping, that is, free of particulate aggregation. Such size reduction is typically carried out to the extent that the product has a smooth mouth feel, that is, no particulate sensation can be perceived in the mouth. Further, it is preferred that the average particle size of the components of the egg-like product is less than about 100 microns, more preferably less than about 50 microns, still more preferably less than about 40 microns and more preferably less than about 30 microns, for example about 20 to about 30 microns. While particle sizes may show some variation in size in any given batch, the average particle size of the egg-like product of the present invention is generally less than about 50 microns, and more preferably less than about 30 microns. It is also preferred that the average particles size is greater than about 0.1 microns and more preferably greater than about 1 micron and most preferably greater than about 10 microns, but less than about 100 microns. It is most preferred that the average particle size range from about 20 microns to about 30 microns. Particle size may be readily determined using methods well known in the art.

To achieve this particle size, the particles of the present invention are reduced in size using specific refiners known in the art. However, not all refiners are capable of effecting this reduction in size to impart the proper mouth feel. Normal grinding such as in screen mills and impact mills cannot be used to achieve the egg-like product of the present invention having the aforementioned average particle size with the characteristics described herein due to heat damage to the products and a tendency for the mills to “blind” as a consequence of caking of the food on the mill surfaces and the screens. Cryogenic milling is an option but such milling is more expensive.

It has been found that use of a roller refining mill, for example a 3-roll horizontal roll mill as used in the paint, ink, pharmaceutical and chocolate industries, is very suitable for achieving the degree of fineness needed to give instant rehydration of the egg white on addition to water at room temperature. Moreover, the milling must be effected in a certain manner. Milling of dry egg white or of soy protein, such as PSM, alone results in large quantities of free-flying fine powder with real problems on an industrial scale. Milling of the egg white and soy protein, e.g., PSM, in admixture optionally with the addition of a fat such as oil and more preferably vegetable oils to the premix facilitates its movement through a roller-milling operation without any free-flying fines and importantly with no detrimental temperature increase. Other types of equipment can achieve a similar result. Where liquid egg white is utilised, a homogeniser, such as a Manton Gaulin-type, may be used to produce a blend having a smooth mouth feel. Optionally the dry ingredients, in conjunction with the oil component can be pre-milled prior to homogenization.

When referring to particle size it is meant that the distance between two points of an imaginary line that extends to the opposite sides of the particle, which line must pass through the middle of the particle. For example, if the particle is a sphere, the average particle size refers to the diameter of the particle.

Other ingredients and additives, described herein may be selected for adding to the premix prior to refining/milling, or they may be admixed after size reduction has been achieved or they may be added during the refining/milling process. These may include flavourants, colorants, vitamins and minerals, pH—adjusting agents, free-flow agents, sweeteners, nutritional supplements, other functional components and the like described above. The resulting product may be pasteurized or homogenized using known technique.

The egg-like product of the present invention is incorporated into food that normally contains eggs and partially or fully replaces the egg present therein. For example, the egg-like product of the present invention may be suitably seasoned and cooked in a simple and conventional way to produce an omelette, fried egg, scrambled eggs, boiled egg, poached egg, and the like. Alternatively, the product of the present invention may be added to foods, in which eggs are utilized, such as egg custards, desserts and the like, or in a quiche, crepe, pancake, waffle, in bakery products such as muffins, cakes, cookies and yeast-leavened products, as a binder in fritters, in batters, mayonnaise, salad dressings, beverages, e.g., egg nog, spreads, beverage, nutritional products or supplements and in any other way one uses normal fresh eggs. When added to foods, the product of the present invention is used in the same way as the natural egg product; it just replaces the natural egg. It is added to the food in the same amount as the natural egg, which the product of the present invention replaces. The food product is prepared in the same way as the product containing the natural egg, except that the egg-like product of the present invention replaces the natural egg.

The egg-like product of the present invention offers the following advantages:
1. substantially cholesterol free, at least about 99% or more cholesterol free;
2. may be prepared at a lower fat content than whole eggs;
3. presented as a dry product which will rehydrate instantly on addition of cold water but may also be presented as a liquid product either refrigerated or frozen;
4. has a long shelf life in its dry form without the need for refrigerator or freezer storage;
5. may be used in such food preparations as omelettes, quiches and the like, in bakery products such as muffins and cakes, in custards and other dessert uses, in mayonnaises and the like, etc.;
6. is lower in cost than fresh eggs;
7. may lead to reduction in blood serum cholesterol levels as part of a suitably balanced diet; and
8. has a nutritional composition similar to whole eggs.

The invention will now be described with reference to the following non-limiting examples:

### EXAMPLE 1

Spray dried egg white powder and PSM along with soy oil were mixed together in the following proportions, using a Kenwood food mixer fitted with a “K” beater, until a free-flowing crumb was formed.

TABLE 1
Fat and Protein Content of Egg-like food product

| | | | |
|---|---|---|---|
| | | Contained | Contained |
| Ingredients | % by weight | Fat (g) | Protein (g) |

| | | | | | |
|---|---|---|---|---|---|
| PSM | 38.1% | 7.6 | g | 16.0 | g |
| Powdered egg white, | 38.1% | 0.0 | g | 33.5 | g |
| spray dried | | | | | |
| Soy oil | 21.5% | 21.5 | g | 0.0 | g |
| Natural coloring, | 2.3% | 0.0 | g | 0.0 | g |
| mineral supplements | | | | | |
| etc. | | | | | |
| Total | 100.0% | 29.1 | g | 49.5 | g |

The resulting crumb preparation was fed through a 3-roll refiner. It passed easily down between the first two rollers then up between the second and third rollers and was removed from the third roller as a fine dry flaky powder. The gaps between the rollers were set so that the final product when tasted produced no particulate sensation on the palate i.e. had a smooth mouth feel.

The refinate, when mixed with water preferably at room temperature or 24° C. (75° F.) e.g. in the proportion of 28 g refinate to 72 g water, could be rapidly dispersed free of lumps by stirring with a fork for about 30 seconds. This liquid, when poured into a hot, buttered pan, set as is typical of regular hen's eggs and could be folded to produce an omelette preparation. The texture, flavour and appearance closely resembled an omelette as normally prepared from regular chicken hen's eggs. The fat content of the final product ranges from about 7% to about 8% by weight.

### EXAMPLE 2

(a) The procedure of Example 1 was repeated except the ingredients of the egg-like product are as indicated hereinbelow:

| | | Contained | Contained Protein |
|---|---|---|---|
| Ingredients | % by weight | Fat (g) | (g) |
| PSM | 47.65% | 9.53 | 20.013 |
| Powdered egg white, | 47.65% | 0 | 38.12 |
| spayed dried | | | |
| Soy Oil | 2.4% | 2.4 | 0 |
| Natural coloring | 2.3% | 0 | 0 |
| mineral supplements, | | | |
| etc. | | | |
| Water | | | |
| Total | 100.0% | 11.93 | 58.133 |

As in Example 1, the ingredients were mixed together until a free flowing crumb was formed. The crumb was passed through a 3-roll refiner, as in Example 1 and was removed from the third roller as a fine dry flaky powder.

The refinate, when mixed with water at room temperature or 24° C. (75° F.) in the proportion of 28 g refinate to 72 g water could be rapidly dispersed free of lumps by stirring with a fork for about 30 seconds. It was then cooled as in Example 1 to produce an acceptable omelette type of food. The fat content of the final product was about 3.34%, while the protein content thereof was about 10.27%.

(b) The procedure of Example 2 was repeated except the ingredients used were as follows:

| | | Contained | | Contained Protein |
|---|---|---|---|---|
| Ingredients | % by weight | Fat (g) | | (g) |
| PSM | 24% | 4.8 | | 10.08 |
| Powdered, egg white, | 67.7% | 0 | | 54.16 |
| spray dried | | | | |
| Soy Oil | 6% | 6 | | 0 |
| Natural coloring, | 2.3% | 0 | | 0 |
| mineral supplements, | | | | |
| etc. | | | | |
| Total | 100.0% | 10.8 | g | 64.24 |

As in Example 2(a), the refinate, when mixed with the proportion of 28 g refinate to 72 g of water at about room temperature or 24° C. (75° F.), was rapidly dispersed free of lumps by stirring with a fork for about 30 seconds. It was then cooked as in Example 1 to produce an acceptable omelette type food. The fat content of the food product was 3.024% and the protein content was about 17.98%.

### EXAMPLE 3

A premix was prepared as in example 1 but in place of PSM, soy isolate was used at a rate, which provided the same protein contribution as was provided by PSM in example 1. The premix was refined as in example 1. The refinate was mixed with water at room temperature or 24° C. (75° F.) at the appropriate rate. The product was rapidly hydrated and became free of clumps by simple whisking with a fork. It was then cooked as in example 1 to produce an acceptable omelette-type food.

### EXAMPLE 4

In this example soy concentrate was used in place of PSM so as to contribute a similar amount of protein as was provided by PSM in example 1. The cooked result resembled that achieved in examples 1 & 3.

### EXAMPLE 5

The products of examples 1, 2 & 3 were also used to prepare a creme caramel dessert following a normal recipe for chicken hen eggs. The resulting dessert was acceptable in every way and was indistinguishable from such a dessert prepared from whole hen eggs.

In all these examples the resulting products represent very acceptable foods, which are free of cholesterol and offer a novel alternative to foods conventionally based on use of hen eggs.

### EXAMPLE 6

Cholesterol-free liquid egg white was prepared by carefully separating the yolks from hen eggs ensuring that no yolk particles contaminate the egg white. Egg white was admixed with PSM and soy oil in accordance with the proportions shown below. The uniformly mixed liquid was homogenised so as to ensure there was no tendency to oil separation. The homogenised liquid was pasteurised as is typical for liquid egg products.

TABLE 2
Recipe of Fat & Protein content of Egg-like food Product

| | | | |
|---|---|---|---|
| | | Contained | Contained |
| Ingredients | % by weight | Fat (g) | Protein (g) |

| Liquid egg white | 63.5% | | | 7.1 | g |
|---|---|---|---|---|---|
| PSM | 12% | 2.4 | g | 5.2 | g |
| Soy Oil | 8.0% | 8.0 | g | — | |
| Water | 16% | — | | — | |
| Minerals & | 0.5% | — | | — | |
| Natural Colorants | | | | | |
| Total | 100.0% | 10.4 | g | 12.3 | g |

It was then either.
(a) stored in clean containers at 4° C. for subsequent use—typical refrigerated shelf life being about 20 days. or:
(b) packaged into plastic pouches of 120 g net, heat sealed and rapidly frozen. The pouches were stored at −20° C. and had a storage life under such conditions in excess of 12 months.

### EXAMPLE 7

The procedure of Example 6 was followed, using the ingredients tabulated hereinbelow:

| | | | |
|---|---|---|---|
| | | Contained | Contained |
| Ingredients | % by weight | Fat (g) | Protein (g) |

| | | | | | |
|---|---|---|---|---|---|
| Liquid egg white | 51.5% | 0 | | 5.768 | g |
| PSM | 24% | 4.8 | g | 10.392 | g |
| Soy Oil | 0% | 0 | g | 0 | |
| Water | 22.2% | 0 | | 0 | |
| Natural Coloring | 2.3% | 0 | | 0 | |
| Total | 100.0% | 4.8 | g | 16.15 | g |

The uniformly mixed liquid was homogenized so as to ensure that there was not tendency for the oil to separate. The homogenized product was pasteurised. The fat content in the final product is about 4.8%.

### EXAMPLE 8

The procedure of Example 6 was followed using the ingredients tabulated in the following table.

| | | | |
|---|---|---|---|
| | | Contained | Contained |
| Ingredients | % by weight | Fat (g) | Protein (g) |

| | | | | | |
|---|---|---|---|---|---|
| Liquid egg white | 51.5% | 0 | | 5.76 | g |
| PSM | 10% | 2 | g | 4.33 | g |
| Soy Oil | 8% | 8 | g | 0 | |
| Water | 28.2% | 0 | | 0 | |
| Natural coloring, | 2.3% | 0 | | 0 | |
| minerals supplements, | | | | | |
| etc. | | | | | |
| Total | 100.0% | 10 | g | 10.09 | g |

The composition containing the above ingredients was uniformly mixed. The uniformly mixed liquid was homogenized so as to ensure that there was no tendency for the oil to separate. The homogenized product was pasteurised.

Either the chilled liquid product or the thawed frozen product can be used in food preparations as an alternative to whole eggs but offers the unique feature of being cholesterol free.

Soy concentrate or soy isolate may be used in place of PSM as has been also described in examples 2 and 3. However PSM is preferred.

While the mechanical treatment or homogenising step described above assists in rendering the particle size of the PSM, soy concentrates or soy isolate smooth in mouth feel, a superior result is achieved by subjecting an admixture of oil and the dry soy component to a refining process as described in example 1, followed by mixing the refinate with liquid egg white and then homogenising the product thus formed.

Throughout this specification and the claims, which follow, unless the context requires otherwise, the word “comprise”, or variations such as “comprises” or “comprising”, will be understood to imply the inclusion of non-stated elements of major or minor functional importance. In other words, the listed steps, elements or options need not be exhaustive.

Unless indicated to the contrary, the percentages used are by dry weight of the product.

Moreover, the plural connotes the singular and vice versa.

The above preferred embodiment and examples were given to illustrate the scope and spirit of the present invention. These embodiments and examples will make apparent to those skilled in the art other embodiments and examples. These other embodiments and examples are with the contemplation of the present invention. Therefore, the present invention should be limited only by the appended claims.

1. An egg-like food product which comprises a soy protein containing component and an egg white, the average particle size of said product being less than about 100 microns, the soy protein containing component being present in at least 10% by weight relative to the egg-like food product.

2. The egg-like food product according to claim 1 which comprises a blend of a soy protein-containing component and egg white component in a weight ratio ranging from about 1:10 to about 2:1.

3. The egg-like food product according to claim 1 which is in the form of a hydratable dried preparation.

4. The egg-like food product according to claim 1 in the form of a liquid preparation.

5. The egg-like food product according to claim 1 wherein the product is prepared by mixing the egg white component and the soy protein containing component together using a roller refining mill.

6. The egg like product according to claim 5 wherein the roller refining mill is a 3 roll mill.

7. The egg like food product according to claim 1 wherein the product has an average particle size of less than about 50 microns.

8. The egg-like food product according to claim 1 wherein the soy protein containing component is PSM.

9. The egg-like food product according to claim 3 wherein the soy protein containing component is present in about 15% to about 50% by weight of the product.

10. The egg-like food product according to claim 4 wherein the egg white component is present in an amount ranging from about 25% to about 45% by weight.

11. The egg-like food product according to claim 4 wherein the egg white component is present in an amount of about 10% to about 90% by weight of the product.

12. The egg-like food product according to claim 11 wherein the egg white component is present in about 40% to about 80% of the product.

13. The egg-like food product according to claim 12 wherein the egg white component is present in about 50% to about 70% of the product.

14. The egg-like product according to claim 1 wherein vegetable oil is additionally present.

15. The egg-like food product according to claim 1 in which the fat content ranges from 2% to about 35%.

16. The egg-like food product according to claim 1 in which the fat content range from about 4% to about 10% by weight at the composition.

17. The egg-like food product according to claim 1 in which the fat content ranges from about 5% to about 9% by weight of the composition.

18. An egg-like food product comprised of dry soy protein containing component, liquid egg white component and vegetable oil, prepared by (a) mixing the soy protein containing component and vegetable oil to form a mixture which is optionally refined in a roller mill, (b) mixing the product of step (a) with the liquid egg white component and (c) subsequently homogenizing the product of step (b), wherein the average particle size of the homogenized product is less than about 100 microns, said soy protein being present in at least 10% by weight of the product, said soy protein, egg white component and vegetable oil being present in amounts effective to impart the flavour, texture and taste to said egg-like product of a natural egg, and said fat content being less than that of natural egg.

19. A process for the production of an egg-like food product which comprises blending a soy protein, with egg white, and optionally one or more fats, and subjecting the dried blend to a mechanical treatment in a roller mill to reduce the average size of the particles to less than about 100 microns, said soy protein being present in at least 10% by weight of the egg-like food product.

20. The process according to claim 19 wherein the soy protein is blended with dried egg white in the presence of one or more fats, to provide a crumb-like admixture and thereafter mechanically refining said mixture.

21. The process according to claim 19 wherein the soy product is blended with liquid egg white in the presence of a fat.

22. The process according to claim 21 wherein the fat is vegetable oil.

23. The process according to claim 19 wherein the soy containing component is soy flour.

24. The process according to claim 19 wherein the soy containing component is PSM.

25. The process according to claim 19 wherein the product thus formed is homogenized or pasteurised.

26. An edible food composition containing the egg-like product of claim 1.

27. The edible food composition of claim 26 which is a cooked or baked product, a binder, dressing, mayonnaise, spread, salad dressing, omelette, boiled egg, poached egg, scrambled egg, fried egg, beverage or nutritional product or supplement.
